(19) United States
(12) Patent Application Publication
(10) Pub. No.: US 2025/0042188 A1
(43) Pub. Date: Feb. 6, 2025

(54) PRINTER

(71) Applicant: Roland DG Corporation, Hamamatsu-shi (JP)

(72) Inventors: Misaki OKUDA, Hamamatsu-shi (JP); Ryosuke NONAKA, Hamamatsu-shi (JP); Naomi YAMAMURA, Hamamatsu-shi (JP)

(21) Appl. No.: 18/773,643

(22) Filed: Jul. 16, 2024

(30) Foreign Application Priority Data
Aug. 1, 2023 (JP) 2023-125534

(51) Int. Cl. B41J 15/04

(52) U.S. Cl. CPC B41J 15/048

(57) ABSTRACT

A printer includes a rolled medium holder to hold a rolled medium that is a band-shaped medium wound into a cylindrical form, and a supporting table to support the medium pulled out rearward from the rolled medium holder. The rolled medium holder includes a rotation shaft extending in a right-left direction and inserted into or through the rolled medium, and a flange provided on at least one end portion of the rotation shaft. A central axis of the rotation shaft is rearward of a front end of the supporting table. A front end of the flange is forward of the front end of the supporting table.

### CROSS REFERENCE TO RELATED APPLICATIONS

This application claims the benefit of priority to Japanese Patent Application No. 2023-125534 filed on Aug. 1, 2023. The entire contents of this application are incorporated herein by reference.

### BACKGROUND OF THE INVENTION

### 1. Field of the Invention

The present invention relates to printers.

### 2. Description of the Related Art

JP 2011-110708 A, for example, discloses a recording apparatus including a body, a platen supported by the body and configured to support a recording medium, and an apron disposed forward of the platen. In the recording apparatus, a holder to hold a rolled medium, which is the recording medium wound into a roll form, is provided in a front portion of the body. The recording medium that has been unrolled from the rolled medium held by the holder passes through a rear portion of the body so as to reach the platen from behind and is then supported by the platen. The recording medium supported by the platen passes through an area on the apron and is then conveyed to a position forward of the apron.

In the recording apparatus disclosed in JP 2011-110708 A, the holder to hold the rolled medium is provided in the front portion of the body. This allows an operator to manually cause the rolled medium to be held by the holder from in front of the body.

In the recording apparatus disclosed in JP 2011-110708 A, a front end of the rolled medium held by the holder is rearward of a front end of the apron. From the viewpoint of facilitating the operator's work to cause the rolled medium to be held by the holder, the rolled medium held by the holder is preferably located as forward as possible. If the rolled medium is located excessively forward, however, the recording medium conveyed forward from the apron will unfortunately enter a space rearward of the rolled medium during rotation of the rolled medium held by the holder. The recording medium conveyed forward from the apron may thus remain in the space rearward of the rolled medium, resulting in damage to the recording medium. If the recording medium remains in the space rearward of the rolled medium, the recording apparatus may fail to smoothly convey the recording medium.

### SUMMARY OF THE INVENTION

Accordingly, example embodiments of the present invention provide printers that are able to smoothly convey media unrolled from rolled media while facilitating rolled media holding work.

A printer according to an example embodiment of the present invention includes a rolled medium holder to hold a rolled medium that is a band-shaped medium wound into a cylindrical form, and a supporting table to support the medium pulled out rearward from the rolled medium holder. The rolled medium holder includes a rotation shaft extending in a right-left direction and inserted into or through the rolled medium, and a flange provided on at least one end portion of the rotation shaft. A central axis of the rotation shaft is rearward of a front end of the supporting table. A front end of the flange is forward of the front end of the supporting table.

When the medium supported by the supporting table, for example, is conveyed forward, the medium moves to a position forward of and below the supporting table. In this example embodiment, the central axis of the rotation shaft is rearward of the front end of the supporting table, making it difficult for the medium, which has been conveyed to the position forward of the supporting table, to enter an area rearward of the rotation shaft through between the supporting table and the flange. Accordingly, the medium is unlikely to enter and remain in the area rearward of the rotation shaft and is thus unlikely to be damaged. The present example embodiment thus enables smooth conveyance of the medium. In the printer, the front end of the flange is forward of the front end of the supporting table, enabling the rolled medium holder to be disposed as forward as possible. The present example embodiment is thus able to facilitate work to cause the rolled medium to be held by the rolled medium holder from in front of the rolled medium holder. Consequently, the present example embodiment is able to facilitate the work to cause the rolled medium to be held by the rolled medium holder from in front of the rolled medium holder while smoothly conveying the medium.

Accordingly, various example embodiments of the present invention provide printers that are able to smoothly convey media unrolled from rolled media while facilitating rolled media holding work.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a printer according to an example embodiment of the present invention.

FIG. 2 is a front view of the printer according to the present example embodiment of the present invention.

FIG. 3 is a front view of an inkjet head and a cutting head.

FIG. 4 is a right side cross-sectional view of the printer according to the present example embodiment of the present invention.

FIG. 5 is a front view of a rolled medium holder.

FIG. 6 is a cross-sectional view equivalent to FIG. 4, with a medium being pulled back.

### DETAILED DESCRIPTION OF THE EXAMPLE EMBODIMENTS

Example embodiments of the present invention will be described below with reference to the drawings. The example embodiments described below are naturally not intended to limit the present invention in any way. Components and elements having the same functions will be identified by the same reference signs and will be described briefly or will not be described when deemed redundant.

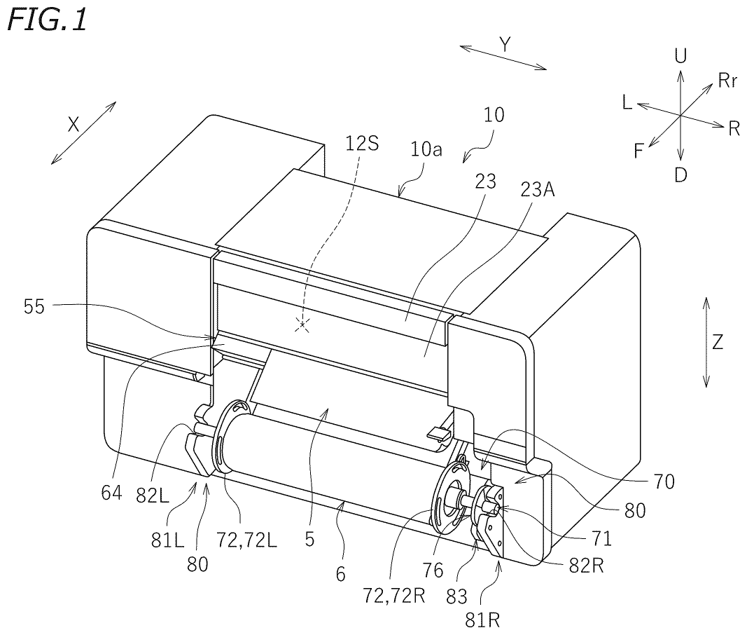

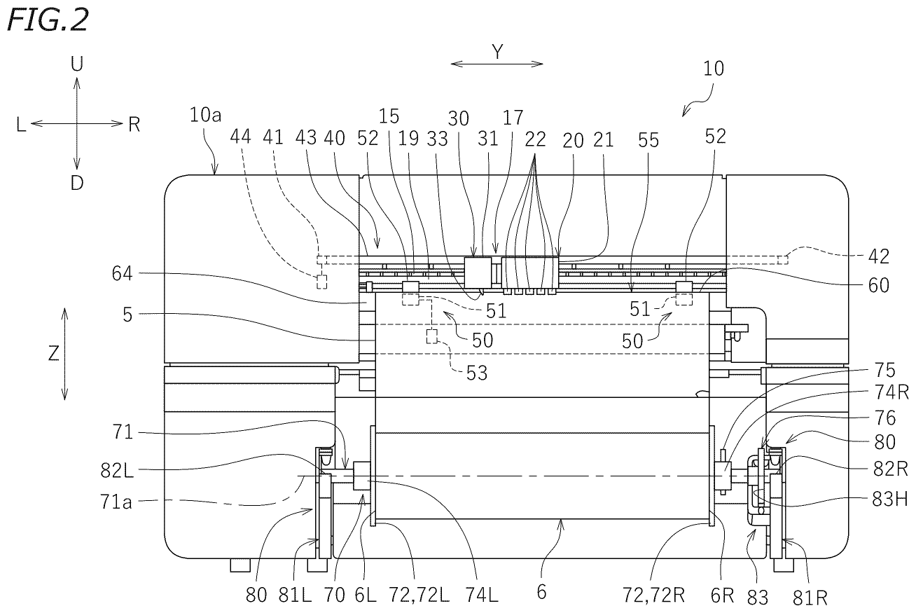

FIG. 1 is a perspective view of a printer 10 according to the present example embodiment. FIG. 2 is a front view of the printer 10 according to the present example embodiment. In the following description, the terms “left”, “right”, “up”, and “down” respectively refer to left, right, up, and down when the printer 10 is viewed from the perspective of an operator in front of the printer 10. A direction away from the rear of the printer 10 and toward the operator is a forward direction. A direction away from the operator and toward the rear of the printer 10 is a rearward direction. The reference signs F, Rr, L, R, U, and D in the drawings respectively represent front, rear, left, right, up, and down. The reference sign Y in the drawings represents a main scanning direction. In the present example embodiment, the main scanning direction Y is a right-left direction. The reference sign X in the drawings represents a sub-scanning direction. The sub-scanning direction X intersects with the main scanning direction Y in a plan view. Specifically, the sub-scanning direction X is perpendicular or substantially perpendicular to the main scanning direction Y in the plan view. In the present example embodiment, the sub-scanning direction X is a front-rear direction. The sub-scanning direction X is an example of a conveyance direction. The reference sign Z in the drawings represents an up-down direction. In the present example embodiment, the up-down direction Z is perpendicular or substantially perpendicular to the main scanning direction Y and the sub-scanning direction X. These directions, however, are defined merely for the sake of convenience and should not be interpreted in a limited sense.

As illustrated in FIG. 1, the printer 10 according to the present example embodiment is a printing and cutting machine that is able to effect printing on a band-shaped medium 5 and to cut the medium 5 (or subject the medium 5 to cutting). Alternatively, the printer 10 may have a printing function but no cutting function. In the present example embodiment, the printer 10 is what is known as an “inkjet printer” that effects printing in an inkjet mode. The printer 10, however, may effect printing in any mode other than an inkjet mode. The printer 10 may be, for example, a dot-impact printer, a laser printer, or a thermal printer.

In the present example embodiment, the medium 5 is, for example, recording paper. The medium 5, however, may be any medium other than recording paper. Examples of the medium 5 may include a sheet made of resin material(s), such as polyvinyl chloride (PVC) and/or polyester, or a sealant including backing paper and a release paper laminated onto the backing paper and having an adhesive applied thereto. As used herein, the terms “cut” and “cutting” may not only refer to cutting an entirety of the medium 5 in its thickness direction (e.g., cutting both of backing paper and release paper of a sealant) but also refer to cutting a portion of the medium 5 in its thickness direction (e.g., cutting only release paper of a sealant without cutting backing paper thereof). In the present example embodiment, the band-shaped medium 5 wound into a cylindrical form is held in the printer 10. The band-shaped medium 5 wound into a cylindrical form will hereinafter be referred to as a “rolled medium 6”.

As illustrated in FIG. 1, the printer 10 includes a printer body 10a having a box shape. An internal space 12S is defined in the printer body 10a. The printer body 10a includes a front cover 23. In this example embodiment, the front cover 23 is supported by the printer body 10a such that the front cover 23 is rotatable around its upper end. Rotating the front cover 23 upward brings the internal space 12S of the printer body 10a into communication with an external space. In the internal space 12S, an inkjet head 21 (see FIG. 2) effects printing on the medium 5, and the cutting head 31 (see FIG. 2) cuts the medium 5. The inkjet head 21 and the cutting head 31 will be described below. The internal space 12S is covered with the front cover 23 as illustrated in FIG. 1, making it difficult for dirt and/or dust to enter the internal space 12S from outside during, for example, printing.

As illustrated in FIG. 1, a lower portion of the front cover 23 is provided with a window 23A. The window 23A is made of, for example, a transparent or semitransparent acrylic plate. The window 23A is processed so as to make it difficult for external light (e.g., ultraviolet light) to reach the internal space 12S. The operator is allowed to visually check the inside of the printer body 10a (which is the internal space 12S in this example embodiment) through the window 23A.

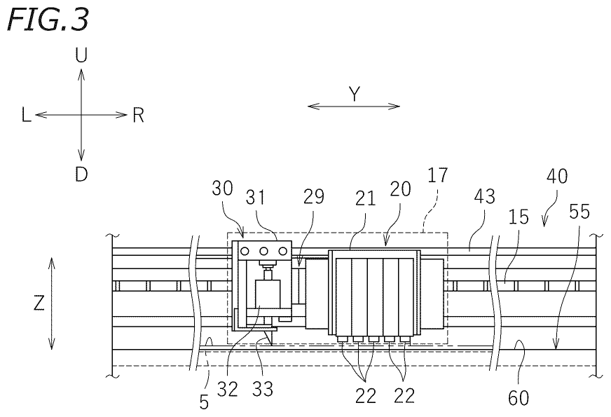

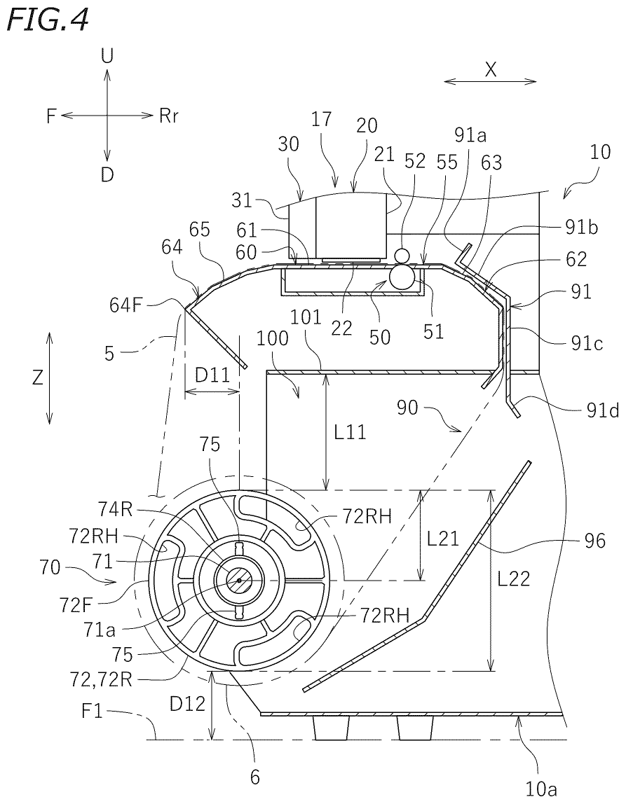

The following description discusses an internal structure of the printer 10. FIG. 3 is a front view of the inkjet head 21 and the cutting head 31. FIG. 4 is a right side cross-sectional view of the printer 10. As illustrated in FIG. 4, the printer 10 includes a supporting table 55. The supporting table 55 supports the medium 5. In this example embodiment, the supporting table 55 includes a platen 60, an upstream apron 62, and a downstream apron 64.

The platen 60 supports the medium 5 while the medium 5 is subjected to printing and/or cutting. The platen 60 includes a supporting surface 61 to support the medium 5. The supporting surface 61 defines an upper surface of the platen 60. The supporting surface 61 is a flat surface extending in the main scanning direction Y and the sub-scanning direction X. In this example embodiment, the medium 5 is located on the supporting surface 61. The medium 5 located on the supporting surface 61 undergoes printing and/or cutting.

In the present example embodiment, the medium 5 is conveyed from an upstream side to a downstream side in the sub-scanning direction X on the platen 60 during printing. As used herein, the term “upstream side in the sub-scanning direction X” refers to a rearward side of the platen 60. As used herein, the term “downstream side in the sub-scanning direction X” refers to a forward side of the platen 60. In this example embodiment, the medium 5 is conveyed from back to front relative to the platen 60 during printing.

The upstream apron 62 is located on the upstream side in the sub-scanning direction X on the platen 60. In this example embodiment, the upstream apron 62 is located behind the platen 60. The upstream apron 62 has, for example, an arc shape in cross section. The upstream apron 62 includes an upstream curved surface 63 curved such that the upstream curved surface 63 extends downward as it extends rearwardly away from the platen 60. The upstream curved surface 63 defines an upper surface of the upstream apron 62. The downstream apron 64 is located on the downstream side in the sub-scanning direction X on the platen 60. In this example embodiment, the downstream apron 64 is located in front of the platen 60. The downstream apron 64 has, for example, an arc shape in cross section. The downstream apron 64 is an example of an apron according to an example embodiment of the present invention. The downstream apron 64 includes a downstream curved surface 65 curved such that the downstream curved surface 65 extends downward as it extends forwardly away from the platen 60. The downstream curved surface 65 defines an upper surface of the downstream apron 64. In the present example embodiment, at least a front end portion of the downstream apron 64 protrudes outward (i.e., forward in this example embodiment) from the internal space 12S (see FIG. 1).

As illustrated in FIG. 2, the printer 10 includes a guide rail 15, a carriage 17, the inkjet head 21, the cutting head 31, a head mover 40, a conveyor 50, a rolled medium holder 70, and a supporting holder 80. The guide rail 15 is located above the platen 60 and the downstream apron 64. Although not illustrated, the guide rail 15 is located above the upstream apron 62. The guide rail 15 extends in the main scanning direction Y. The guide rail 15 is secured to, for example, a body frame 19 extending in the main scanning direction Y in the printer body 10a.

As illustrated in FIG. 2, the carriage 17 is supported by the guide rail 15. The carriage 17 is slidable in the main scanning direction Y relative to the guide rail 15. In this example embodiment, the carriage 17 is located at a position immediately above the platen 60 and overlapping with the platen 60 in the sub-scanning direction X in a plan view. In this example embodiment, the carriage 17 includes an ink head carriage 20 and a cutting carriage 30. The ink head carriage 20 is provided with the inkjet head 21. The cutting carriage 30 is provided with the cutting head 31. In this example embodiment, movement of the carriage 17 in the main scanning direction Y results in movement of the inkjet head 21 and the cutting head 31 in the main scanning direction Y. In the present example embodiment, the cutting carriage 30 is located to the left of the ink head carriage 20. Alternatively, the cutting carriage 30 may be disposed to the right of the ink head carriage 20. In this example embodiment, the ink head carriage 20 and the cutting carriage 30 are connected to each other through a connecter 29 as illustrated in FIG. 3. The ink head carriage 20 and the cutting carriage 30 thus move concurrently in the main scanning direction Y.

The inkjet head 21 effects printing on the medium 5 supported by the platen 60. The inkjet head 21 is movable in the main scanning direction Y. The inkjet head 21 includes at least one recording head 22 that includes a plurality of nozzles (not illustrated) to discharge ink. The inkjet head 21 may include any suitable number of recording heads 22. In the present example embodiment, the number of recording heads 22 is five, and the five recording heads 22 are supported by the ink head carriage 20. The five recording heads 22 are disposed side by side in the main scanning direction Y. The five recording heads 22 discharge different colors of ink. In this example embodiment, each of the recording heads 22 discharges any of the following colors of ink: process color ink, such as cyan ink, magenta ink, yellow ink, and black ink, and spot color ink, such as clear ink and white ink, which are different from process color ink.

The cutting head 31 cuts the medium 5 supported by the platen 60. The cutting head 31 is configured to be movable in the main scanning direction Y. As illustrated in FIG. 3, the cutting head 31 includes a solenoid 32 and a cutter 33. The cutter 33 is attached to the cutting carriage 30 through the solenoid 32. In this example embodiment, turning ON/OFF the solenoid 32 moves the cutter 33 in the up-down direction Z such that the cutter 33 comes into contact with the medium 5 or moves away from the medium 5. In the present example embodiment, the cutter 33 cuts the medium 5 in accordance with, for example, cutting data and is able to cut the medium 5 not only in a linear fashion but also in a curved fashion.

The head mover 40 causes the carriage 17 (i.e., the inkjet head 21 and the cutting head 31) to move with respect to the medium 5, which is supported by the platen 60, in the main scanning direction Y. The head mover 40 moves the carriage 17 in the main scanning direction Y. The head mover 40 is not limited to any particular configuration, structure, or arrangement. As illustrated in FIG. 2, the head mover 40 includes a left pulley 41, a right pulley 42, a belt 43, and a carriage motor 44. The left pulley 41 is provided around a left end portion of the guide rail 15. The right pulley 42 is provided around a right end portion of the guide rail 15. The belt 43 is, for example, an endless belt. The belt 43 is wound around the left pulley 41 and the right pulley 42. The belt 43 is secured to an upper back surface of the carriage 17. In this example embodiment, the left pulley 41 is connected with the carriage motor 44. In the present example embodiment, the carriage motor 44 is activated so as to rotate the left pulley 41, causing the belt 43 to run between the left pulley 41 and the right pulley 42. This moves the carriage 17 in the main scanning direction Y. The movement of the carriage 17 in the main scanning direction Y results in movement of the ink head carriage 20 and the cutting carriage 30 in the main scanning direction Y, causing the inkjet head 21 (which includes the five recording heads 22 in this example embodiment) and the cutting head 31 (which includes the cutter 33 in this example embodiment) to move in the main scanning direction Y.

The conveyor 50 causes the medium 5, which is supported by the platen 60, to move relative to the carriage 17 in the sub-scanning direction X. In this example embodiment, the conveyor 50 moves the medium 5, which is supported by the platen 60, in the sub-scanning direction X. The conveyor 50 is not limited to any particular configuration, structure, or arrangement. In the present example embodiment, the conveyor 50 includes grit rollers 51, pinch rollers 52, and a feed motor 53. The grit rollers 51 are provided in the platen 60. In this example embodiment, the grit rollers 51 are embedded in the platen 60 such that upper portions of the grit rollers 51 are exposed as illustrated in FIG. 4. As illustrated in FIG. 2, the grit rollers 51 are in alignment with each other in the main scanning direction Y. The conveyor 50 may include any suitable number of grit rollers 51. The pinch rollers 52 are disposed over the grit rollers 51. The medium 5 is caught between the pinch rollers 52 and the grit rollers 51 such that the pinch rollers 52 press down the medium 5. The feed motor 53 is connected to the grit roller(s) 51. In this example embodiment, with the medium 5 caught between the grit rollers 51 and the pinch rollers 52, the feed motor 53 is activated so as to rotate the grit rollers 51. Upon rotation of the grit rollers 51, the medium 5 supported by the platen 60 is conveyed in the sub-scanning direction X. The medium 5 supported by the platen 60 is conveyed by the conveyor 50 from front to back or from back to front relative to the platen 60.

The following description discusses the rolled medium holder 70. As illustrated in FIG. 2, the rolled medium holder 70 holds the rolled medium 6, which is the band-shaped medium 5 wound into a cylindrical form. The medium 5 that has been unrolled from the rolled medium 6 held by the rolled medium holder 70 is supplied onto the supporting table 55. The supporting table 55 is configured to support the medium 5 pulled out rearward from the rolled medium holder 70.

As illustrated in FIG. 4, the rolled medium holder 70 is located in a lower front portion of the printer body 10a. The rolled medium holder 70 is located below the platen 60, the upstream apron 62, and the downstream apron 64. At least a portion of the rolled medium holder 70 is forward of the platen 60 and the downstream apron 64. An entirety of the rolled medium holder 70 is forward of the upstream apron 62. At least a portion of the rolled medium holder 70 is forward of the inkjet head 21 and the cutting head 31. In this example embodiment, the operator is allowed to conduct work to cause the rolled medium 6 to be held by the rolled medium holder 70 from in front of the printer 10.

The medium 5 that has been unrolled from the rolled medium 6 held by the rolled medium holder 70 passes through the printer body 10a (or passes below the platen 60), runs along the upstream curved surface 63 of the upstream apron 62, and is then supported by the platen 60 (i.e., located on the supporting surface 61). The medium 5 supported by the platen 60 is conveyed to the downstream apron 64, runs along the downstream curved surface 65 of the downstream apron 64, and is then conveyed to a location forward of the downstream apron 64.

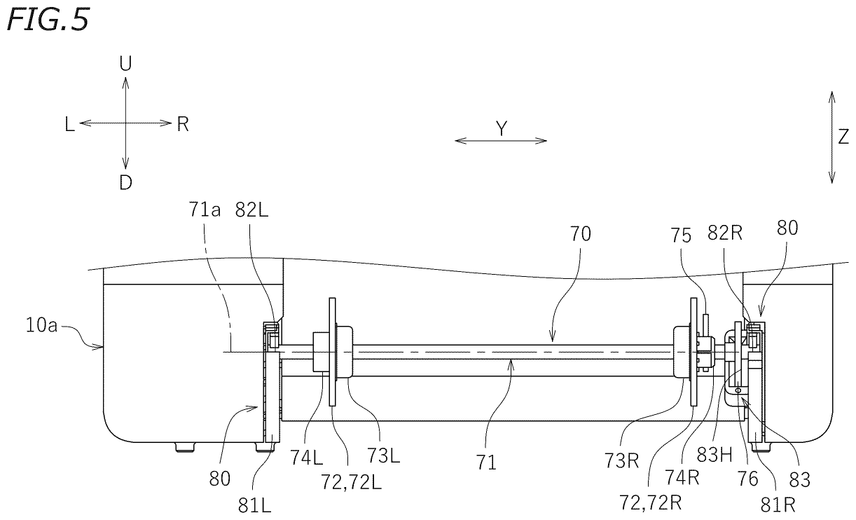

FIG. 5 is a front view of the rolled medium holder 70. In FIG. 5, the rolled medium 6 is not illustrated. As illustrated in FIG. 5, the rolled medium holder 70 includes a rotation shaft 71, a flange 72, and a positioning flange 76. As illustrated in FIG. 2, the rotation shaft 71 extends in the main scanning direction Y. As illustrated in FIG. 2, the rotation shaft 71 is inserted into or through the rolled medium 6. The rotation shaft 71 is a portion of the rolled medium holder 70 supported by a supporting holder 80. The rotation shaft 71 is longer in length than the platen 60 in the main scanning direction Y. In this example embodiment, a central axis 71a of the rotation shaft 71 extends in the main scanning direction Y. The rolled medium 6 having the rotation shaft 71 inserted thereinto or therethrough is rotatable around the central axis 71.

The flange 72 is provided on at least one end portion of the rotation shaft 71. At least one end portion of the rolled medium 6 in the main scanning direction Y is allowed to abut against the flange 72. In the present example embodiment, the flange 72 includes two flanges, one of which is provided on a left end portion of the rotation shaft 71 and the other one of which is provided on a right end portion of the rotation shaft 71. Alternatively, the flange 72 may be a single flange provided on either one of the right and left end portions of the rotation shaft 71. In this example embodiment, the flange 72 includes a right flange 72R which is provided on the right end portion of the rotation shaft 71 and against which a right end portion 6R of the rolled medium 6 is allowed to abut, and a left flange 72L which is provided on the left end portion of the rotation shaft 71 and against which a left end portion 6L of the rolled medium 6 is allowed to abut.

The right flange 72R is secured to the rotation shaft 71. The right flange 72R restricts rightward movement of the rolled medium 6. As illustrated in FIG. 4, the right flange 72R has a disc shape. In the present example embodiment, the right flange 72R is provided with at least one through hole 72RH passing through the right flange 72R in the main scanning direction Y. In this example embodiment, the number of through holes 72RH provided in the right flange 72R is three, and the three through holes 72RH are arranged in a circumferential direction of the right flange 72R. The through holes 72RH are arranged at equal intervals. The through holes 72RH each have an oblong shape extending in the circumferential direction of the right flange 72R.

In the present example embodiment, a right holder 73R is provided on the left of the right flange 72R as illustrated in FIG. 5. A right cylinder 74R is provided on the right of the right flange 72R. In this example embodiment, the right flange 72R, the right holder 73R, and the right cylinder 74R are integral with each other. The right holder 73R holds the right end portion 6R (see FIG. 2) of the rolled medium 6. In this example embodiment, the right holder 73R is inserted and fitted into the right end portion 6R of the rolled medium 6. The right holder 73R has a cylindrical shape. The right holder 73R is smaller in diameter than the right flange 72R. At least one securing pin 75 is inserted into a circumferential portion of the right cylinder 74R. With the at least one securing pin 75, the right cylinder 74R is secured to the rotation shaft 71. The right cylinder 74R has a cylindrical shape. The right cylinder 74R is smaller in diameter than the right holder 73R.

As illustrated in FIG. 5, the left flange 72L is provided on the left end portion of the rotation shaft 71. In this example embodiment, the left flange 72L is movable in the main scanning direction Y along the rotation shaft 71. The left flange 72L is not secured to the rotation shaft 71 (which means that the left flange 72L is movably attached to the rotation shaft 71). The left flange 72L restricts leftward movement of the rolled medium 6. The left flange 72L has a disc shape. Although not illustrated, the left flange 72L is provided with through hole(s) similar to the through hole(s) 72RH provided in the right flange 72R. In the present example embodiment, the left flange 72L is equal in diameter to the right flange 72R.

In the present example embodiment, a left holder 73L is provided on the right of the left flange 72L. A left cylinder 74L is provided on the left of the left flange 72L. In this example embodiment, the left flange 72L, the left holder 73L, and the left cylinder 74L are integral with each other. The left holder 73L holds the left end portion 6L (see FIG. 2) of the rolled medium 6. In this example embodiment, the left holder 73L is inserted and fitted into the left end portion 6L of the rolled medium 6. The left holder 73L has a cylindrical shape. The left holder 73L is smaller in diameter than the left flange 72L. The left holder 73L is equal in diameter to the right holder 73R. The left cylinder 74L has a cylindrical shape. The left cylinder 74L is smaller in diameter than the left holder 73L.

As illustrated in FIG. 5, the positioning flange 76 is located rightward of the right flange 72R. The positioning flange 76 is secured to the rotation shaft 71. In this example embodiment, the relative positions of the positioning flange 76 and the right flange 72R remain unchanged. The positioning flange 76 has a disc shape. In this example embodiment, the positioning flange 76 is smaller in diameter than the right flange 72R and smaller in diameter than the left flange 72L. At least a portion of the positioning flange 76 is housed in a positioning determiner 83 (which will be described below).

The supporting holder 80 supports the rolled medium holder 70 such that the rolled medium holder 70 is rotatable. The rolled medium holder 70 is attachable to and detachable from the supporting holder 80. The supporting holder 80 is provided in the printer body 10a. Although not illustrated, the supporting holder 80 is located below the platen 60, the upstream apron 62, and the downstream apron 64. The supporting holder 80 is forward of the platen 60. As illustrated in FIG. 5, the supporting holder 80 includes a left support portion 81L, a right support portion 81R, and the positioning determiner 83.

The left support portion 81L and the right support portion 81R support the rotation shaft 71 such that the rotation shaft 71 is rotatable. The rotation shaft 71 is attachable to and detachable from the left support portion 81L and the right support portion 81R. The left support portion 81L and the right support portion 81R are provided in the printer body 10a. As illustrated in FIG. 2, the left support portion 81L and the right support portion 81R are provided below the platen 60. In this example embodiment, the left support portion 81L is provided leftward of the platen 60, and the right support portion 81R is provided rightward of the platen 60. In the present example embodiment, the right support portion 81R is provided with a right recess 82R recessed obliquely rearward and downward as illustrated in FIG. 1. The left support portion 81L is provided with a left recess 82L recessed obliquely rearward and downward as illustrated in FIG. 1. The rotation shaft 71 is rotatably disposed in the left recess 82L and the right recess 82R. In this example embodiment, the rotation shaft 71 is allowed to be disposed in the left recess 82L and the right recess 82R from in front of the left recess 82L and the right recess 82R.

As illustrated in FIG. 5, the positioning determiner 83 is provided on the right support portion 81R. The positioning determiner 83 is located on the left of the right support portion 81R. With the rotation shaft 71 supported by the left support portion 81L and the right support portion 81R, the positioning determiner 83 houses a portion of the positioning flange 76. The positioning determiner 83 determines the position of the positioning flange 76 in the main scanning direction Y. Specifically, a portion of the positioning flange 76 is housed in the positioning determiner 83, with the result that the position of the rolled medium holder 70 relative to the supporting holder 80 is determined uniquely. In the present example embodiment, the positioning determiner 83 is provided with an insertion hole 83H. The insertion hole 83H is defined such that the insertion hole 83H extends downward from an upper surface of the positioning determiner 83. A portion of the positioning flange 76 is inserted into the insertion hole 83H. The position of the rolled medium holder 70 relative to the supporting holder 80 is thus determined by the insertion of a portion of the positioning flange 76 into the insertion hole 83H.

In the present example embodiment, the printer body 10a is provided with a conveyance path 90 as illustrated in FIG. 4. The medium 5 supplied from the rolled medium holder 70 (i.e., the medium 5 unrolled from the rolled medium 6 held by the rolled medium holder 70) passes through the conveyance path 90. The conveyance path 90 is defined such that the conveyance path 90 runs from the rolled medium holder 70 to a position behind the platen 60. To be more specific, the conveyance path 90 extends rearward from the rolled medium holder 70 and extends obliquely rearward and upward to a rear end of the upstream apron 62. The conveyance path 90 then extends along the upstream curved surface 63 of the upstream apron 62 so as to reach the position behind the platen 60.

In the present example embodiment, the printer body 10a is provided with a guide 91 to guide a portion of the conveyance path 90. The guide 91 is in the form of a plate located away from the upstream curved surface 63 and extending along the upstream curved surface 63 above the upstream apron 62. In the present example embodiment, the guide 91 may include a first guide portion 91a extending obliquely forward and downward above the upstream apron 62, a second guide portion 91b extending obliquely rearward and downward from a lower end of the first guide portion 91a, a third guide portion 91c extending downward from a lower end of the second guide portion 91b, and a fourth guide portion 91d extending obliquely rearward and downward from a lower end of the third guide portion 91c. In this example embodiment, the third guide portion 91c is located behind the upstream apron 62 such that the third guide portion 91c is located at a predetermined interval from the upstream apron 62. Thus, a gap between the guide 91 and the upstream curved surface 63 of the upstream apron 62 defines a portion of the conveyance path 90.

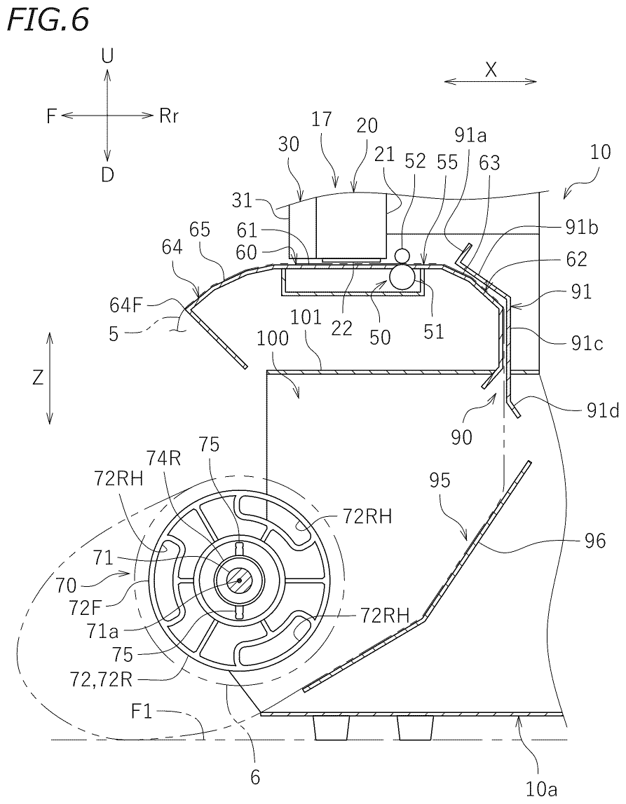

In the present example embodiment, the medium 5 passes through the conveyance path 90 and is then conveyed in the sub-scanning direction X from back to front relative to the platen 60 during printing as illustrated in FIG. 4. FIG. 6 is a cross-sectional view equivalent to FIG. 4, with the medium 5 being pulled back. When the medium 5 undergoes cutting, the medium 5 is conveyed from back to front relative to the platen 60 or pulled back from front to back relative to the platen 60 as illustrated in FIG. 6. When the medium 5 is pulled back during cutting, the medium 5 is conveyed from the platen 60 to the upstream apron 62 and is then conveyed downward from the rear end of the upstream apron 62. In the present example embodiment, the printer body 10a is provided with a pullback path 95. When the medium 5 supported by the supporting table 55 (e.g., the platen 60) is pulled back rearward, the pulled back medium 5 passes through the pullback path 95. A portion of the pullback path 95 overlaps with the conveyance path 90. In this example embodiment, the pullback path 95 extends along the upstream curved surface 63 of the upstream apron 62 from behind the platen 60 and extends downward from the rear end of the upstream apron 62. The pullback path 95 then extends obliquely forward and downward and passes below the rolled medium holder 70.

In the present example embodiment, the printer body 10a is provided with a pullback guide 96 to guide a portion of the pullback path 95. The pullback guide 96 is a plate-shaped member. The pullback guide 96 defines at least a portion of the pullback path 95. In this example embodiment, the pullback guide 96 runs along a lower edge of the pullback path 95 extending obliquely forward and downward. The pullback guide 96 is located behind the rolled medium holder 70 and under the supporting table 55. The pullback guide 96 is inclined downward toward a space between a floor surface F1 and a portion of the flange 72 closest to the floor surface F1. The pullback guide 96 is located behind the rolled medium holder 70 and under the platen 60 and the upstream apron 62. The pullback guide 96 is inclined obliquely forward and downward. In the present example embodiment, a lower end of the pullback guide 96 is located below the rolled medium holder 70. To be more specific, the lower end of the pullback guide 96 is located below the flange 72 in a side view.

In the present example embodiment, as illustrated in FIG. 4, the operator manually conducts a series of operations including pulling out the medium 5 rearward from the rolled medium 6 held by the rolled medium holder 70, passing the medium 5 through the conveyance path 90, and causing the medium 5 to be supported by the platen 60. Accordingly, a work space 100 for the operator to conduct the series of operations is defined above the rolled medium holder 70 in a front view. In this example embodiment, a partition 101 is provided between the rolled medium holder 70 and the supporting table 55 (e.g., the platen 60). The partition 101 is in the form of a plate extending in the main scanning direction Y and the sub-scanning direction X. The work space 100 is defined between the flange 72 and the partition 101 in the side view. The work space 100 is in communication with the conveyance path 90. This allows the operator to stretch his or her hand(s) into the work space 100 from in front of the work space 100 so as to reach the conveyance path 90.

The following description discusses the location of the rolled medium holder 70. In the present example embodiment, the rolled medium holder 70 is located in the front portion of the printer body 10a as illustrated in FIG. 4. In this example embodiment, the central axis 71a of the rotation shaft 71 included in the rolled medium holder 70 is rearward of a front end 64F of the downstream apron 64. A front end of the rotation shaft 71 is rearward of the front end 64F of the downstream apron 64. In this example embodiment, a distance D11 in the sub-scanning direction X (which is the front-rear direction in this example embodiment) between the front end 64F of the downstream apron 64 and the central axis 71a of the rotation shaft 71 is 45 mm or more. In the present example embodiment, a front end 72F of the flange 72 (which includes the left flange 72L and the right flange 72R in this example embodiment) of the rolled medium holder 70 is forward of the front end 64F of the downstream apron 64. In other words, the front end 64F of the downstream apron 64 is located between the front end 72F of the flange 72 and the central axis 71a of the rotation shaft 71 in the side view. In this example embodiment, a front end of the rolled medium 6 when the rolled medium 6 held by the rolled medium holder 70 has a maximum diameter (i.e., when the rolled medium 6 is in a brand new and unused condition) is forward of the front end 64F of the downstream apron 64. In the present example embodiment, the term “front end 64F of the downstream apron 64” is synonymous with the front end 64F of the supporting table 55.

As previously mentioned, the work space 100 is defined between the partition 101 and the flange 72 in the side view. In this example embodiment, an up-down space length L11 of the work space 100 in the up-down direction Z, which is measured between the partition 101 and an uppermost position of the flange 72 in the up-down direction Z, is such that the operator is allowed to put his or her hand(s) into the work space 100. In this example embodiment, the up-down space length L11 of the work space 100 is longer than about one-half of a length of the flange 72 in the up-down direction Z (i.e., a radius L21 of the flange 72). As used herein, the term “flange 72” not only refers to the left flange 72L but also refers to the right flange 72R. The up-down space length L11 of the work space 100 is, for example, about 90 mm or more. The up-down space length L11 of the work space 100 is shorter than the length of the flange 72 in the up-down direction Z (i.e., a diameter L22 of the flange 72). As used herein, the term “up-down space length L11 of the work space 100” refers to the dimension of a front opening of the work space 100 in the up-down direction Z.

In the present example embodiment, the printer body 10a may be installed on the floor surface F1, for example. The rolled medium holder 70 is located upwardly away from the floor surface F1. In this example embodiment, a distance in the up-down direction Z between the floor surface F1 and a portion of the flange 72 closest to the floor surface F1 (e.g., a lower end of the flange 72) will be referred to as a “distance D12”. In this example embodiment, the distance D12 in the up-down direction z between the floor surface F1 and the flange 72 is shorter than the up-down space length L11 of the work space 100. The distance D12 in the up-down direction Z between the floor surface F1 and the flange 72 is longer than the distance D11 in the front-rear direction (i.e., the sub-scanning direction X) between the front end 64F of the downstream apron 64 and the central axis 71a of the rotation shaft 71. The distance D12 in the up-down direction Z between the floor surface F1 and the portion of the flange 72 closest to the floor surface F1 is, for example, about 65 mm or more.

As illustrated in FIG. 2, the present example embodiment involves causing the rolled medium holder 70, with its rotation shaft 71 inserted into or through the rolled medium 6, to be supported by the supporting holder 80. This operation includes disposing the left end portion of the rotation shaft 71 in the left recess 82L of the left support portion 81L of the supporting holder 80, disposing the right end portion of the rotation shaft 71 in the right recess 82R of the right support portion 81R of the supporting holder 80, and inserting a portion of the positioning flange 76 into the insertion hole 83H of the positioning determiner 83. Conducting this operation enables the rolled medium holder 70 to be supported by the supporting holder 80.

The operator then causes the medium 5, which has been unrolled from the rolled medium 6, to be supported by the platen 60. As illustrated in FIG. 4, this operation involves unrolling the medium 5 rearward from the rolled medium 6 held by the rolled medium holder 70. The operator puts his or her hand(s) into the work space 100 from in front of the printer body 10a so as to grasp the medium 5, which has been unrolled from the rolled medium 6, with his or her hand(s). The operator then inserts the medium 5, which is grasped with his or her hand(s), into the conveyance path 90 defined between the upstream curved surface 63 of the upstream apron 62 and the guide 91. The medium 5, which has been inserted into the conveyance path 90 defined between the upstream apron 62 and the guide 91, is moved to the platen 60 along the guide 91 and is then supported by the platen 60 (i.e., located on the supporting surface 61 of the platen 60). The medium 5 located on the supporting surface 61 of the platen 60 is subsequently caught between the grit rollers 51 and the pinch rollers 52, enabling conveyance of the medium 5.

As illustrated in FIG. 4, the printer 10 according to the present example embodiment described above includes the rolled medium holder 70 to hold the rolled medium 6, which is the band-shaped medium 5 wound into a cylindrical form, and the supporting table 55 to support the medium 5 pulled out rearward from the rolled medium holder 70. As illustrated in FIG. 2, the rolled medium holder 70 includes the rotation shaft 71 extending in the main scanning direction Y and inserted into or through the rolled medium 6, and the flange 72 including the right flange 72R and the left flange 72L respectively provided on the right and left end portions of the rotation shaft 71. As illustrated in FIG. 4, the central axis 71a of the rotation shaft 71 is rearward of the front end 64F of the supporting table 55 (i.e., the front end 64F of the downstream apron 64 in this example embodiment). The front end 72F of the flange 72 is forward of the front end 64F of the supporting table 55 (i.e., the downstream apron 64 in this example embodiment). In the present example embodiment, when the medium 5 supported by the downstream apron 64, for example, is conveyed forward, the medium 5 moves to a position forward of and below the downstream apron 64 and above the flange 72. In this example embodiment, the central axis 71a of the rotation shaft 71 is rearward of the front end 64F of the downstream apron 64, making it difficult for the medium 5, which has been conveyed to the position forward of the downstream apron 64, to enter an area rearward of the rotation shaft 71 through between the downstream apron 64 and the flange 72 (or the rolled medium 6). Because the medium 5 is unlikely to enter the area rearward of the rotation shaft 71 through between the downstream apron 64 and the flange 72 (or the rolled medium 6), the medium 5 is unlikely to remain in a space rearward of the rolled medium 6 and to be damaged. The present example embodiment thus enables smooth conveyance of the medium 5. In the present example embodiment, the front end 72F of the flange 72 is forward of the front end 64F of the downstream apron 64, enabling the rolled medium holder 70 to be disposed as forward as possible. Thus, when the flange 72 is grasped from in front of the printer 10 so as to cause the rolled medium 6 to be held by the rolled medium holder 70, the present example embodiment is able to facilitate work to cause the rolled medium 6 to be held by the rolled medium holder 70 from in front of the rolled medium holder 70 without interfering with the downstream apron 64. Consequently, the present example embodiment is able to facilitate the work to cause the rolled medium 6 to be held by the rolled medium holder 70 from in front of the rolled medium holder 70 while smoothly conveying the medium 5.

In the present example embodiment, as illustrated in FIG. 4, the distance D11 in the front-rear direction (i.e., the sub-scanning direction X) between the front end 64F of the downstream apron 64 and the central axis 71a of the rotation shaft 71 is set at, for example, about 45 mm or more. Setting the distance D11 at about 45 mm or more, for example, in this manner enables the central axis 71a of the rotation shaft 71 to be located more rearward. Accordingly, the medium 5 conveyed to a position forward of the downstream apron 64 is unlikely to enter an area rearward of the rotation shaft 71 through between the downstream apron 64 and the flange 72 (or the rolled medium 6).

In the present example embodiment, the rolled medium holder 70 is located below the supporting table 55 as illustrated in FIG. 4. The printer 10 includes the partition 101 provided between the rolled medium holder 70 and the supporting table 55 and extending in the front-rear direction (i.e., the sub-scanning direction X). The work space 100 in communication with the conveyance path 90 is defined between the partition 101 and the flange 72 in the side view. In this example embodiment, the up-down space length L11 of the work space 100 in the up-down direction Z, which is measured between the partition 101 and the uppermost position of the flange 72 in the up-down direction Z, is longer than about one-half of the length of the flange 72 in the up-down direction Z (i.e., the radius L21 of the flange 72). The present example embodiment is thus able to increase the up-down space length L11 of the work space 100. Accordingly, the operator is allowed to stretch his or her hand(s) into the work space 100 from in front of the work space 100 so as to easily conduct work to cause the medium 5, which has been unrolled from the rolled medium 6 held by the rolled medium holder 70, to be supported by the platen 60.

In the present example embodiment, the up-down space length L11 of the work space 100 is, for example, about 90 mm or more. This allows the operator to easily put his or her hand(s) into the work space 100 from in front of the work space 100. Accordingly, the operator is allowed to stretch his or her hand(s) into the work space 100 from in front of the work space 100 so as to more easily conduct the work to cause the medium 5, which has been unrolled from the rolled medium 6 held by the rolled medium holder 70, to be supported by the platen 60.

In the present example embodiment, the up-down space length L11 of the work space 100 is shorter than the length of the flange 72 in the up-down direction Z (i.e., the diameter L22 of the flange 72). The up-down space length L11 of the work space 100 is thus prevented from being excessively long. Accordingly, the present example embodiment is able to facilitate the operator's work to cause the medium 5, which has been unrolled from the rolled medium 6 held by the rolled medium holder 70, to be supported by the platen 60, while preventing an increase in the size of the printer 10.

In the present example embodiment, the medium 5 supported by the supporting table 55 is conveyed from the upstream side to the downstream side or from the downstream side to the upstream side in the sub-scanning direction X. The printer body 10a is installed on the floor surface F1. The printer body 10a supports the rolled medium holder 70 and the supporting table 55 (which includes the platen 60, the upstream apron 62, and the downstream apron 64 in this example embodiment). The distance D12 in the up-down direction Z between the floor surface F1 and the portion of the flange 72 closest to the floor surface F1 is longer than the distance D11 in the front-rear direction (i.e., the sub-scanning direction X) between the front end 64F of the downstream apron 64 and the central axis 71a of the rotation shaft 71. The present example embodiment is thus able to increase the distance D12 in the up-down direction Z between the floor surface F1 and the portion of the flange 72 closest to the floor surface F1. The medium 5 supported by the platen 60, for example, may be pulled back rearward. The medium 5 pulled back from the platen 60 may enter an area between the floor surface F1 and the portion of the flange 72 closest to the floor surface F1 in the side view. Suppose that the distance between the floor surface F1 and the portion of the flange 72 closest to the floor surface F1 is insufficient in the side view. In this case, when the medium 5 is pulled back from the supporting table 55 (or more specifically, the platen 60), the wound medium 5 held by the rolled medium holder 70 may sag and hang down toward the floor surface F1. The medium 5 pulled back from the supporting table 55 may be caught between the floor surface F1 and the medium 5 hanging down toward the floor surface F1, which may result in a paper jam. The present example embodiment, however, is able to increase the distance D12 in the up-down direction Z between the floor surface F1 and the portion of the flange 72 closest to the floor surface F1. Consequently, the present example embodiment facilitates the passage of the pulled back medium 5 through a gap between the floor surface F1 and the portion of the flange 72 closest to the floor surface F1, making it unlikely that the medium 5 will be jammed.

In the present example embodiment, the distance D12 in the up-down direction Z between the floor surface F1 and the flange 72 is, for example, about 65 mm or more. Thus, a sufficient gap is left between the floor surface F1 and the flange 72, making it more unlikely that the pulled back medium 5 will be jammed in the gap between the floor surface F1 and the flange 72.

As illustrated in FIG. 6, the printer 10 according to the present example embodiment includes the pullback path 95 through which, when the medium 5 supported by the supporting table 55 is pulled back rearward, the pulled back medium 5 passes, and the pullback guide 96 defining at least a portion of the pullback path 95, located behind the rolled medium holder 70 and under the supporting table 55, and inclined downward toward the space between the floor surface F1 and the portion of the flange 72 closest to the floor surface F1. When the medium 5 supported by the supporting table 55 is pulled back rearward, the medium 5 pulled back rearward passes through the pullback path 95 and moves along the pullback guide 96 defining at least a portion of the pullback path 95 and inclined downward toward the space between the floor surface F1 and the portion of the flange 72 closest to the floor surface F1. The present example embodiment thus facilitates guiding of the pulled back medium 5 from behind the supporting table 55 into the gap between the floor surface F1 and the portion of the flange 72 closest to the floor surface F1 along the pullback guide 96. Because the sufficient gap is left between the floor surface F1 and the portion of the flange 72 closest to the floor surface F1, the pulled back medium 5 would be unlikely to be jammed in the gap between the floor surface F1 and the portion of the flange 72 closest to the floor surface F1 if the guiding of the pulled back medium 5 into the gap is facilitated.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer comprising:
a rolled medium holder to hold a rolled medium that is a band-shaped medium wound into a cylindrical form; and
a supporting table to support the medium pulled out rearward from the rolled medium holder; wherein
the rolled medium holder includes:
a rotation shaft extending in a right-left direction and inserted into or through the rolled medium; and
a flange provided on at least one end portion of the rotation shaft;
a central axis of the rotation shaft is rearward of a front end of the supporting table; and
a front end of the flange is forward of the front end of the supporting table.

2. The printer according to claim 1, further comprising a partition between the rolled medium holder and the supporting table and extending in a front-rear direction; wherein
a work space is defined between the partition and the flange in a side view; and
an up-down space length of the work space in an up-down direction between the partition and an uppermost position of the flange in the up-down direction is longer than about one-half of a length of the flange in the up-down direction.

3. The printer according to claim 2, wherein the up-down space length of the work space is shorter than the length of the flange in the up-down direction.

4. The printer according to claim 1, further comprising:
a conveyor to convey the medium supported by the supporting table from an upstream side to a downstream side or from the downstream side to the upstream side in a conveyance direction; and
a printer body installed on a floor surface and supporting the rolled medium holder and the supporting table; wherein
a distance in an up-down direction between the floor surface and a portion of the flange closest to the floor surface is longer than a distance in a front-rear direction between the front end of the supporting table and the central axis of the rotation shaft.

5. The printer according to claim 4, further comprising:
a pullback path through which, when the medium supported by the supporting table is pulled back rearward, the pulled back medium passes; and
a pullback guide defining at least a portion of the pullback path, located behind the rolled medium holder and under the supporting table, and inclined downward toward a space between the floor surface and the portion of the flange closest to the floor surface.
